(19) United States
(12) Patent Application Publication
(10) Pub. No.: US 2026/0178362 A1
(43) Pub. Date: Jun. 25, 2026

(54) LLM EXECUTION ENGINE APPARATUS AND METHOD THEREOF

(71) Applicant: UNIVERSITY INDUSTRY FOUNDATION, YONSEI UNIVERSITY, Seoul (KR)

(72) Inventors: Yoon Noh LEE, Seoul (KR); Yongseung YU, Seoul (KR); Yongjun PARK, Seoul (KR)

(73) Assignee: UNIVERSITY INDUSTRY FOUNDATION, YONSEI UNIVERSITY, Seoul (KR)

(21) Appl. No.: 19/058,567

(22) Filed: Feb. 20, 2025

(30) Foreign Application Priority Data
Dec. 20, 2024 (KR) 10-2024-0193033

(51) Int. Cl. G06F 9/455; G06F 7/544; G06T 11/20

(52) U.S. Cl. CPC G06F 9/45533; G06F 7/544; G06T 11/26

(57) ABSTRACT

The present disclosure relates to a Large Language Model (LLM) execution engine apparatus, where the LLM execution engine apparatus comprises a graph rewriter that analyzes an Open Neural Network Exchange (ONNX) graph and converts the graph into a Tensor Virtual Machine (TVM) graph and a runtime engine unit that compiles the TVM graph into an executable binary.

### CROSS-REFERENCE TO RELATED APPLICATIONS

The present application is based upon and claims the benefit of priority to Korean Patent Application No. 10-2024-0193033, filed on Dec. 20, 2024. The disclosures of the above-listed applications are hereby incorporated by reference herein in their entirety.

### TECHNICAL FIELD

The present disclosure relates to a large language model (LLM) technology and more specifically, to an LLM execution engine apparatus and method capable of rewriting an LLM model in the Open Neural Network Exchange (ONNX) format into a Tensor Virtual Machine (TVM) graph and converting the graph into a binary form executable on a hardware accelerator such as a GPU, thereby improving LLM inference performance.

### BACKGROUND

In the field of artificial intelligence (AI), natural language processing (NLP) has been evolving to implement human-level language understanding and generation capabilities by utilizing Large Language Models (LLMs). The LLMs comprise more than billions of parameters and are pre-trained on massive text datasets, exhibiting excellent performance in tasks such as contextual understanding, question answering, and conversation generation.

However, as the scale of the model increases, a problem arises in that the inference process demands a significantly larger amount of computation, time, and resources. The problem is particularly critical for online services or applications that require real-time responses, where improving inference speed and ensuring efficient utilization of resources are essential. To address the problem, hardware accelerators such as Graphics Processing Units (GPUs) are being widely adopted, and techniques optimized to the characteristics of the corresponding hardware are recognized as crucial.

Meanwhile, due to the availability of various deep learning frameworks (e.g., TensorFlow, PyTorch) and standard model format (e.g., ONNX), interoperability and portability between models have also emerged as key issues. ONNX provides a format that facilitates model reuse across diverse environments; however, for optimal execution of a model in actual hardware-accelerated environments, additional steps such as optimization, compilation, and transformation are required.

Furthermore, various libraries for hardware acceleration (e.g., cuBLAS, CUTLASS) and model optimization toolchains (e.g., TVM) have been developed, offering diverse approaches to maximize model execution efficiency. However, synergistic integration and efficient application of the elements above to meet specific requirements of each model and hardware characteristics are not straightforward. Developers or operators often encounter considerable trial and error and invest substantial time due to issues such as interoperability, performance variations, and configuration complexity among components.

Therefore, the current state of the art requires an integrated and automated design of an execution engine, intended to efficiently operate large-scale models such as LLMs in various hardware-accelerated environments.

The Korean Patent No. 10-2024-0123936 (Aug. 16, 2024) relates to a method and apparatus for accelerating deep learning neural network models, which provides a method that designates an acceleration cluster based on at least one connection layer and multiple operation layers included in a deep learning network and determines common quantization parameters applied to activation values for the designated acceleration cluster.

The method for accelerating a deep learning neural network comprises performing a search on the layers included in the deep learning neural network to detect at least one connection layer and a plurality of operation layers connected to the input of the at least one connection layer, designating an acceleration cluster based on the at least one connection layer and the plurality of operation layers, and determining common parameters for the acceleration cluster based on activation values for the acceleration cluster.

### PRIOR ART REFERENCES

### Patent Document

Korean patent publication No. 10-2024-0123936 (Aug. 16, 2024)

### SUMMARY

One embodiment of the present disclosure provides an LLM execution engine apparatus and method that rewrites an LLM model in the Open Neural Network Exchange (ONNX) format into a Tensor Virtual Machine (TVM) graph and converts the graph into a binary form executable on a hardware acceleration device such as GPU, thereby enhancing the LLM inference performance.

Another embodiment of the present disclosure provides an LLM execution engine apparatus and method that converts an LLM model into an Open Neural Network Exchange (ONNX) graph mainly using a graph rewriter, modifies weights of the corresponding ONNX graph into variables in the ONNX graph to be compatible with CUTLASS and cuBLAS, identifies a computational pattern, and splits the ONNX graph based on the patterns to generate a Tensor Virtual Machine (TVM) graph, thereby enhancing the LLM inference performance.

Yet another embodiment of the present disclosure provides an LLM execution engine apparatus and method that performs an optimal tiling search by searching for CUTLASS tiling parameters mainly using a runtime engine unit which receives a Tensor Virtual Machine (TVM) graph as input, generates CUTLASS and cuBLAS modules based on the corresponding configuration, compares execution performances of the two generated modules, and selects the optimal module to generate binaries, thereby supporting LLM inference using the generated binaries in GPU environments and maximizing the efficiency of LLM execution.

Among embodiments, a Large Language Model (LLM) execution engine apparatus comprises a graph rewriter that analyzes an Open Neural Network Exchange (ONNX) graph and converts the graph into a Tensor Virtual Machine (TVM) graph and a runtime engine unit that compiles the TVM graph into an executable binary.

The graph rewriter may convert an LLM model into the ONNX graph, and the ONNX graph may include an ONNX graph generation member that defines input data as variables and weights as constants. The graph rewriter may further include an ONNX graph processing member that transforms constant data types in the ONNX graph into variable data types, modifies the ONNX graph into a form compatible with CUDA Templates for Linear Algebra Subroutines (CUTLASS) and CUDA Basic Linear Algebra Subroutines (cuBLAS), and identifies a computational pattern. The graph rewriter may further include a TVM graph generation member that splits the modified ONNX graph based on the computational pattern to generate the TVM graph. The graph rewriter may determine the computational pattern mainly from General Matrix Multiplication (GEMM) operations.

The runtime engine unit may include a process of receiving the TVM graph and searching for optimal tiling parameters for each node of the TVM graph. The runtime engine unit may further include an execution performance comparison member that generates CUTLASS and cuBLAS modules based on the tiling configuration and compares their execution performances. The runtime engine unit may further include a binary generation member that selects one of the CUTLASS and cuBLAS modules to generate the binary. The runtime engine unit may further include a binary execution member that performs LLM inference using the binary in a GPU environment.

Among other embodiments, an LLM execution engine apparatus may comprise a graph rewriter that analyzes an ONNX graph and converts the graph into a TVM graph and a runtime engine unit that compiles the TVM graph into a binary, wherein the graph rewriter may convert an LLM model into the ONNX graph that defines input data as variables and weights as constants, transform the constants in the ONNX graph into the variables, modify the ONNX graph into a form compatible with CUTLASS and cuBLAS, identify a computational pattern, and split the modified ONNX graph based on the computational pattern to generate the TVM graph; and the runtime engine unit may receive the TVM graph and perform tiling configuration by searching for tiling parameters of the TVM graph, generate CUTLASS and cuBLAS modules based on the tiling configuration and compare their execution performances, select one of the CUTLASS and cuBLAS modules to generate the binary, and perform LLM inference using the binary in a GPU environment.

Among yet other embodiments, an LLM execution engine method performed by an LLM execution engine apparatus comprise a graph rewriting step that analyzes an ONNX graph and converts the graph into a TVM graph and a runtime engine step that compiles the TVM graph into an executable binary.

The present disclosure provides the following effects. However, since it is not meant that a specific embodiment has to provide all of or only the following effects, the technical scope of the present disclosure should not be regarded as being limited by the specific embodiment.

The LLM execution engine apparatus and method according to one embodiment of the present disclosure rewrites an LLM model in the ONNX format into a TVM graph and converts the graph into a binary executable on a hardware accelerator such as GPU, thereby improving the LLM inference performance.

The LLM execution engine apparatus and method according to one embodiment of the present disclosure converts an LLM model into the ONNX graph mainly using a graph rewriter, transforms weights in the corresponding ONNX graph into a variable form, modifies the ONNX graph into a form compatible with CUTLASS and cuBLAS, identifies a computational pattern, and splits the modified ONNX graph based on the computational pattern to generate the TVM graph, thereby improving the LLM inference performance.

The LLM execution engine apparatus and method according to one embodiment of the present disclosure performs an optimal tiling parameter search mainly using a runtime engine unit that receives the TVM graph as input, generates CUTLASS and cuBLAS modules based on the corresponding configuration, and compares execution performances of the two modules, and selects the optimal module to generate binaries, thereby supporting LLM inference using the generated binaries in GPU environments and maximizing the efficiency of LLM execution.

### BRIEF DESCRIPTION OF THE DRAWINGS

FIG. 1 illustrates an LLM execution engine system according to one embodiment of the present disclosure.

FIG. 2 illustrates the system structure of the LLM execution engine apparatus of FIG. 1.

FIG. 3 illustrates the functional structure of the LLM execution engine apparatus of FIG. 1.

FIG. 4 illustrates the functional structure and step-by-step optimization process of a graph re-writer 310 and a runtime engine unit 320 executed in the LLM execution engine apparatus of FIG. 1.

FIG. 5 is a flow diagram illustrating the LLM execution engine procedure performed in the LLM execution engine apparatus of FIG. 1.

FIG. 6 illustrates graph optimization and execution process based on the conventional methods, CUTLASS and TVM BYOC.

FIG. 7 shows comparison of General Matrix Multiplication (GEMM) operation performances according to conventional methods.

FIG. 8 illustrates the step-by-step search process for optimizing the tiling configuration of CUTLASS according to conventional methods.

FIG. 9 illustrates CUTLASS-friendly graph intermediate representation (IR) transformation according to conventional methods.

FIG. 10 illustrates a process of maximizing utilization of computational resources of GPU by applying the Split-K algorithm to the Batch GEMM operation.

FIG. 11 is a diagram of comparing LLM single-precision inference performances of CUrator and other frameworks in diverse GPU environments.

FIG. 12 is a diagram comparing half-precision LLM inference performances measured on RTX3090, A6000, RTX4090, and A100 GPUs.

FIG. 13 is a diagram evaluating single-precision inference performance of the BERT model by comparing the CUTLASS-friendly graph IR and the conventional graph IR.

FIG. 14 is a diagram comparing the performance obtained by applying the Split-K option to Batch GEMM in the BERT model and the performance obtained when the Split-K option is not applied.

FIG. 15 illustrates an evaluation result when an auto-tuner is introduced to the CUTLASS backend for the OpenLlama-3B model.

### DETAILED DESCRIPTION

A description of the present disclosure is merely an embodiment for a structural or functional description and the scope of the present disclosure should not be construed as being limited by an embodiment described in a text. That is, since the embodiment can be variously changed and have various forms, the scope of the present disclosure should be understood to include equivalents capable of realizing the technical spirit. Further, it should be understood that since a specific embodiment should include all objects or effects or include only the effect, the scope of the present disclosure is limited by the object or effect.

Meanwhile, meanings of terms described in the present application should be understood as follows.

The terms “first,” “second,” and the like are used to differentiate a certain component from other components, but the scope of should not be construed to be limited by the terms. For example, a first component may be referred to as a second component, and similarly, the second component may be referred to as the first component.

It should be understood that, when it is described that a component is “connected to” another component, the component may be directly connected to another component or a third component may be present therebetween. In contrast, it should be understood that, when it is described that an element is “directly connected to” another element, it is understood that no element is present between the element and another element. Meanwhile, other expressions describing the relationship of the components, that is, expressions such as “between” and “directly between” or “adjacent to” and “directly adjacent to” should be similarly interpreted.

It is to be understood that the singular expression encompasses a plurality of expressions unless the context clearly dictates otherwise and it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In each step, reference numerals (e.g., a, b, c, etc.) are used for convenience of description, the reference numerals are not used to describe the order of the steps and unless otherwise stated, it may occur differently from the order specified. That is, the respective steps may be performed similarly to the specified order, performed substantially simultaneously, and performed in an opposite order.

The present disclosure can be implemented as a computer-readable code on a computer-readable recording medium and the computer-readable recording medium includes all types of recording devices for storing data that can be read by a computer system. Examples of the computer readable recording medium may include a ROM, a RAM, a CD-ROM, a magnetic tape, a floppy disk, an optical data storage device, and the like. Further, the computer readable recording media may be stored and executed as codes which may be distributed in the computer system connected through a network and read by a computer in a distribution method.

If it is not contrarily defined, all terms used herein have the same meanings as those generally understood by those skilled in the art. Terms which are defined in a generally used dictionary should be interpreted to have the same meanings as the meanings in the context of the related art, and are not interpreted as ideal meanings or excessively formal meanings unless clearly defined in the present application.

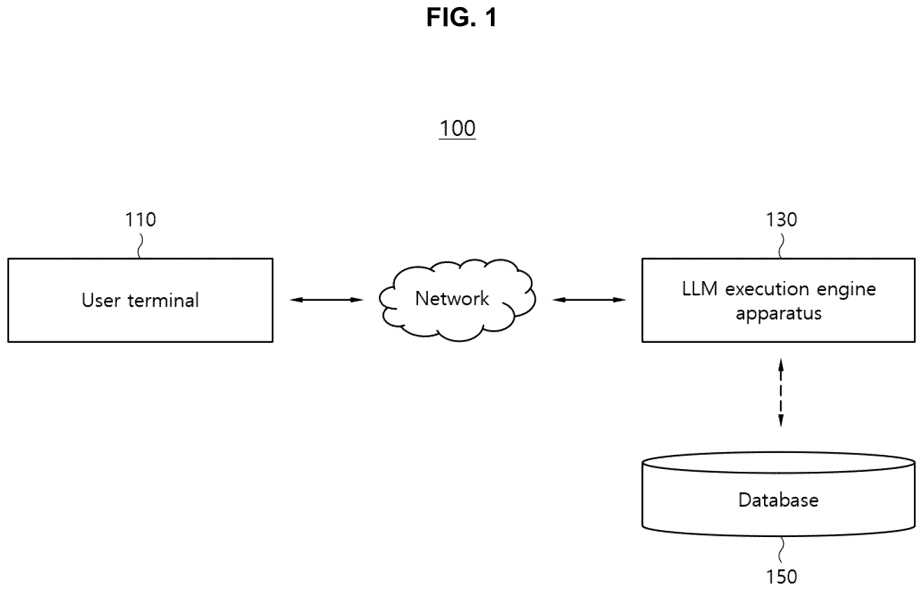

FIG. 1 illustrates an LLM execution engine system according to one embodiment of the present disclosure.

Referring to FIG. 1, the LLM execution engine system 100 may comprise a user terminal 110, an LLM execution engine apparatus 130, and a database 150.

The user terminal 110 may correspond to a computing device capable of providing LLM model execution results and related information to the user. To this end, the user terminal 110 may install a dedicated application or software to receive and process resultant data linked to the LLM model execution engine in real-time and provide LLM inference results to the user. For example, the dedicated application may display output data generated by the LLM model in a visual or auditory form and provide an interface easily understood by the user.

The user terminal 110 may be configured as a single device or multiple devices; In the case of multiple devices, the user terminal 110 may include a first user terminal, a second user terminal, and an n-th (where n is a natural number) user terminal. For example, the user terminal 110 may be implemented as a smartphone, a laptop, or a computer operatively connected to the LLM execution engine apparatus 130; however, the implementation is not limited to the specific examples above and may be implemented using various devices such as tablet PCs. Also, the user terminal 110 is not necessarily limited to the specific example but may be linked to the LLM execution engine apparatus 130 via a network; multiple user terminals 110 may be connected to the LLM execution engine apparatus 130 simultaneously.

The LLM execution engine apparatus 130 according to the present disclosure may be implemented as a server that analyzes an Open Neural Network Exchange (ONNX) graph, converts the ONNX graph into a Tensor Virtual Machine (TVM) graph, and compiles the TVM graph into an executable binary to perform optimized LLM inference on a hardware acceleration device. For example, the LLM execution engine apparatus 130 may be implemented as a server that performs graph rewriting and runtime optimization for LLM models, supports efficient LLM inference through functions such as tiling configuration, operation pattern analysis, and optimized execution module generation. The LLM execution engine apparatus 130 may be connected to the user terminal 110 via a wired network or wireless networks such as Bluetooth, WiFi, or LTE, and transmit and receive data to and from the user terminal 110 over the wired and wireless networks.

Also, the LLM execution engine apparatus 130 may be implemented to operate in connection with an independent external system (not shown in FIG. 1). For example, the LLM execution engine apparatus 130 may interact with a database, cloud storage, or an external system that provides data and configuration information required for executing an LLM model.

The database 150 may serve as a storage device that stores various types of information necessary for the operation of the LLM execution engine apparatus 130. For example, the database 150 may store information such as LLM model graph data, compiled binary data, configuration parameters for execution optimization, and inference result data.

Also, the database 150 may provide resources for analysis of optimized performance of the LLM execution engine, recording of inference results, and management of configuration data based on the stored information. The database 150 may interact with the LLM execution engine apparatus 130 to store real-time data or provide analysis results to other components of the system and deliver data to the user terminal 110.

In FIG. 1, the database 150 is illustrated as a device separate from the LLM execution engine apparatus 130; however, the database 150 is not limited to the specific configuration and may also be integrated into the LLM execution engine apparatus 130.

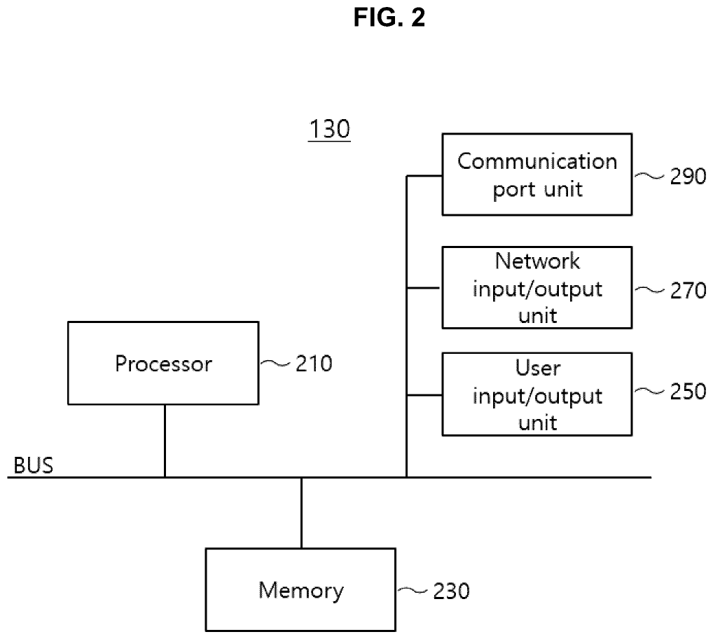

FIG. 2 illustrates the system structure of the LLM execution engine apparatus of FIG. 1.

Referring to FIG. 2, the LLM execution engine apparatus 130 may comprise a processor 210, a memory 230, a user input/output unit 250, a network input/output unit 270, and a communication port unit 290.

The processor 210 according to an embodiment of the present disclosure may perform a graph rewriting function to analyze an Open Neural Network Exchange (ONNX) graph and convert the ONNX graph into a Tensor Virtual Machine (TVM) graph and a binary compilation function through a runtime engine. The processor 210 may manage the memory 230 being read or written during the process above and schedule synchronization timings between volatile and non-volatile memories within the memory 230. The processor 210 may optimize the ONNX graph through the graph rewriter and perform tiling configuration, selection of an optimized module, and binary generation through the runtime engine unit. Also, the processor 210 may control the overall operations of the LLM execution engine apparatus 130 and control data flows between the memory 230, the user input/output unit 250, and the network input/output unit 270 by being electrically connected thereto. The processor 210 may be implemented as a Central Processing Unit (CPU), a Graphics Processing Unit (GPU), or a Neural Processing Unit (NPU) of the LLM execution engine apparatus 130, where the GPU and NPU may be used for LLM model optimization and hardware-accelerated computations.

The memory 230 may include an auxiliary storage device implemented as a non-volatile memory, such as a Solid State Disk (SSD) or a Hard Disk Drive (HDD), to store the overall data required by the LLM execution engine apparatus 130 and a main memory device implemented as a volatile memory, such as a Random Access Memory (RAM). The memory 230 stores ONNX graphs, converted TVM graphs, tiling configuration data, optimized execution modules (e.g., CUTLASS, cuBLAS), and execution result data, supporting quick reference or reuse of intermediate execution results. Also, being executed by the processor 210 electrically connected to the memory 230, the memory 230 may store a command set for performing graph rewriting and runtime engine steps.

The user input/output unit 250 may include an environment for receiving user input; an environment for outputting specific information to the user; input devices that include adapters such as a touchpad, a touchscreen, a virtual keyboard, or a pointing device; and output devices that include adapters such as a monitor or a touchscreen. In one embodiment, the user input/output unit 250 may correspond to a computing device accessed remotely, in which case the LLM execution engine apparatus 130 operates as an independent server. The user input/output unit 250 performs the role of receiving LLM execution requests and input data and providing execution results to the user.

The network input/output unit 270 may provide a communication environment for connecting with the user terminal 110 through a network; for example, the network input/output unit 270 may include adapters for communication over Local Area Network (LAN), Metropolitan Area Network (MAN), Wide Area Network (WAN), and Value Added Network (VAN). Also, for wireless transmission of data, the network input/output unit 270 may be implemented to provide a short-range communication function such as WiFi or Bluetooth or a wireless communication function based on 4G or higher. The network input/output unit 270 may receive LLM model execution requests from the user terminal 110 and transmit the processed result data to the user terminal 110 in real-time.

The communication port unit 290 may be implemented as a port mapping table that performs data routing during the process of transmitting and receiving data through a network. Here, the communication port unit 290 assigns a unique source port to each user terminal 110, thereby distinguishing communication sessions between the user terminal 110 and the server and preventing data collisions during data transmission and reception. Also, the communication port unit 290 may support simultaneous connections with a plurality of user terminals and manage the state of each session.

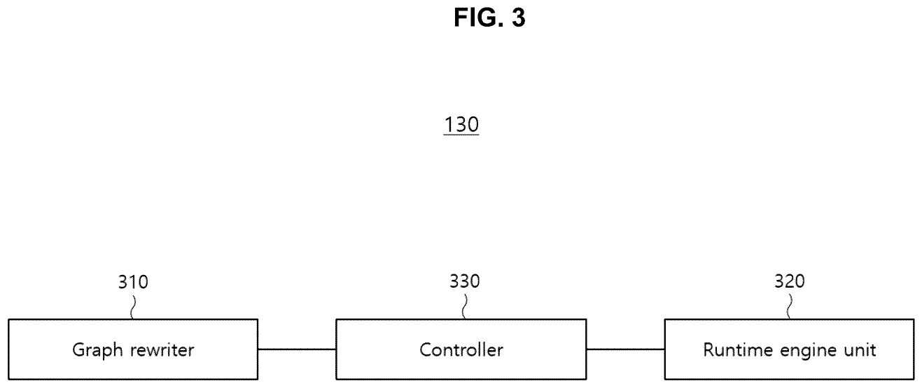

FIG. 3 illustrates the functional structure of the LLM execution engine apparatus of FIG. 1.

Referring to FIG. 3, the LLM execution engine apparatus 130 may comprise a graph rewriter 310, a runtime engine unit 320, and a controller 330.

The LLM execution engine apparatus 130 does not necessarily have to include all of the functional components simultaneously; depending on the respective embodiments, some of the components may be omitted, or some or all of the components may be selectively included. Also, the LLM execution engine apparatus 130 may be implemented as an independent module that selectively includes part of the components and may perform the LLM execution engine functionality according to the present disclosure through interoperation among individual modules. In what follows, the operations of individual components will be described in detail.

The graph rewriter 310 may perform the function of analyzing an Open Neural Network Exchange (ONNX) graph and converting the graph into a Tensor Virtual Machine (TVM) graph to process a Large Language Model (LLM) model. The graph rewriter 310 may efficiently transform weights and input data, identifies a computational pattern, and generate an optimized TVM graph.

The graph rewriter 310 may generate an ONNX graph by receiving the LLM model as input. The graph rewriter 310 may process input data by defining the input data as variables and treating weights as constants. For example, the graph rewriter 310 may set the input sequence of a GPT model as a TensorVariable and define the weights of the Transformer layer as TensorConstant.

The graph rewriter 310 may convert weight constants in the ONNX graph into variables and reconstruct the graph into a form compatible with CUDA Templates for Linear Algebra Subroutines (CUTLASS) and CUDA Basic Linear Algebra Subroutines (cuBLAS).

The graph rewriter 310 may analyze the computational pattern to optimize or simplify unnecessary operations mainly from General Matrix Multiplication (GEMM) operations.

The graph rewriter 310 may generate a TVM graph by merging or splitting nodes of the ONNX graph based on the identified computational pattern. For example, the graph rewriter 310 may merge nodes where GEMM operations and Add operations frequently occur into a single node or split them as needed to provide an optimized execution path.

The graph rewriter 310 may analyze the ONNX graph of the GPT model to configure input data as variables and weights as constants. The graph rewriter 310 may identify a computational pattern mainly from the GEMM operations performed in the self-attention layer of the Transformer structure and converts constant data into variables to maximize parallel processing efficiency through the CUTLASS and cuBLAS libraries. The graph rewriter 310 may split the ONNX graph based on the finally identified computational pattern, generate a TVM graph, and convert the TVM graph to be executable on a GPU.

The graph rewriter 310 may analyze the Fully Connected layers of the BERT model and perform optimization mainly based on the GEMM operation pattern repeated in each node. For example, the graph rewriter 310 may apply tiling based on the size of operation nodes to maximize GPU memory bandwidth and generate an optimized TVM graph by merging operation nodes and eliminating redundant nodes.

The graph rewriter 310 may receive not only the ONNX graph but also other types of graph, such as TensorFlow Lite or PyTorch Script, and convert the graph into a TVM graph. Through the process above, the graph rewriter 310 may integrate a model generated through various deep learning frameworks into an optimized execution environment.

The graph rewriter 310 may rewrite the graph to be compatible with OpenCL-based computational accelerator environments and reduce memory usage by 8-bit quantization of weight data. For example, in mobile environments with limited memory bandwidth, the graph rewriter 310 may quantize weight data and minimize the number of graph nodes to improve execution speed.

The graph rewriter 310 may analyze not only the computational pattern but also the memory access pattern to minimize data transfer between the CPU and GPU. For example, the graph rewriter 310 may merge operation nodes to increase memory cache utilization and rearrange the order of operation nodes to reduce bottlenecks in GPU memory access.

To conclude, the graph rewriter 310 may perform a key role of analyzing the ONNX graph of the LLM model and generating an optimized TVM graph. Through the operation above, the graph rewriter 310 may enable efficient parallel computation tailored to various hardware environments employing, e.g., GPUs, CPUs, and OpenCL accelerators.

The runtime engine unit 320 is a constituting element that receives the Tensor Virtual Machine (TVM) graph as input, compiles the TVM graph into an executable binary, and provides an optimized execution environment. The runtime engine unit 320 may perform various optimization tasks for efficient execution of Large Language Model (LLM) models on hardware acceleration devices (e.g., GPUs, CPUs, and FPGAs).

The runtime engine unit 320 may include a tiling execution member that receives the TVM graph as input, searches for tiling parameters, and performs the optimal tiling configuration. Here, the tiling configuration refers to the process of determining the optimal tile size by considering the memory bandwidth and characteristics of the compute core of the hardware.

The runtime engine unit 320 may search for the optimal tile size (e.g., 64×64) for each operation node and configure GPU core utilization and memory usage to be in balance. For example, the runtime engine unit 320 may analyze the TVM graph of the GPT model and apply the tiling size suitable for the characteristics of each operation node. The runtime engine unit 320 may perform optimization by dynamically adjusting tiling size based on GPU memory usage or execution time or searching for a specific tiling configuration for each operation node.

The runtime engine unit 320 may include an execution performance comparison member that generates CUTLASS and cuBLAS modules based on the tiling configuration and compares their execution performance using the same input data. The runtime engine unit 320 may evaluate the features such as execution time, memory utilization, and power consumption of the generated modules to select a module suitable for a hardware environment. For example, the runtime engine unit 320 may measure the execution times of the CUTLASS and cuBLAS modules using input data from the BERT model and select a module that provides optimal performance under specific hardware conditions. In an environment where the memory bandwidth of the GPU is restricted, the CUTLASS module of the runtime engine unit 320 may maximize the memory utilization and provide better performance. Conversely, when a significant number of computations is required, such as when large-scale matrix operations are involved, the cuBLAS module of the runtime engine unit 320 may exhibit more efficient performance.

The runtime engine unit 320 may include a binary generation member that generates executable binaries based on the selected module. If the CUTLASS module provides faster performance, the runtime engine unit 320 may generate the binary using the CUTLASS module. Conversely, if the cuBLAS module provides more efficient performance, the runtime engine unit 320 may select the cuBLAS module to generate an optimized executable file.

Also, the runtime engine unit 320 may generate both the CUTLASS and cuBLAS modules for the same input data and evaluate the state of the runtime environment to select a suitable binary in real-time. The runtime engine unit 320 may compare execution performances among various acceleration devices, such as GPUs and Tensor Processing Units (TPUs), and configure the optimal execution path depending on the states.

The runtime engine unit 320 may include a binary execution member to perform LLM inference in a GPU environment using the optimized binary. For example, the runtime engine unit 320 may execute the binary generated by an NVIDIAA100 GPU to perform LLM inference and perform a task of predicting the next word based on the input sequence of the GPT model. The runtime engine unit 320 may also be configured to execute binaries on FPGA-based hardware in addition to the GPU environment or perform a large-scale inference task using multiple GPUs in parallel in a cloud environment.

The controller 330 may control the overall operation of the LLM execution engine apparatus 130 and manage the control flow or data flow between the graph rewriter 310 and the runtime engine unit 320.

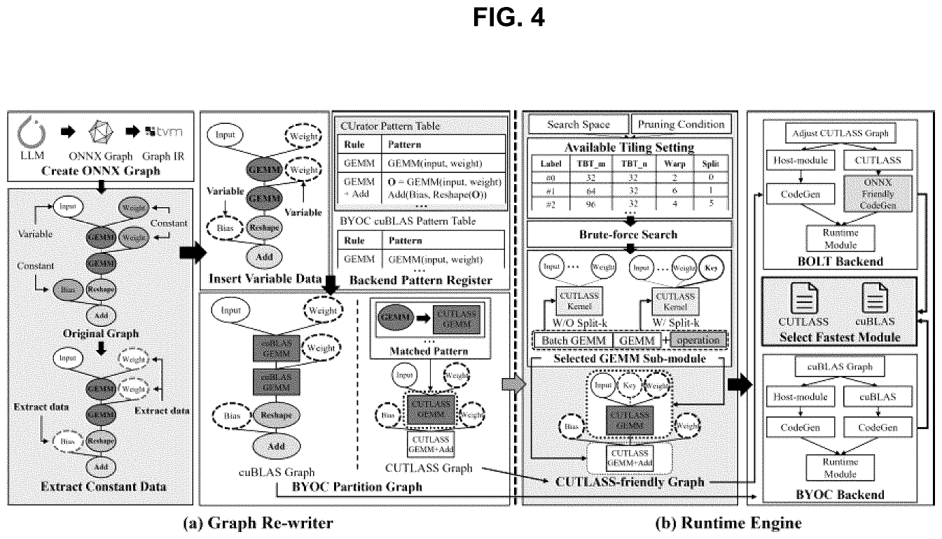

FIG. 4 illustrates the functional structure and step-by-step optimization process of the graph re-writer 310 and the runtime engine unit 320 executed in the LLM execution engine apparatus of FIG. 1.

FIG. 4 illustrates the entire process in which the LLM execution engine apparatus 130 analyzes and converts the Open Neural Network Exchange (ONNX) graph of an input LLM model and subsequently generates and executes an optimized runtime binary.

The graph rewriter 310 receives an LLM model as input, generates an ONNX graph, and converts the ONNX graph into a Tensor Virtual Machine (TVM) graph. During this process, the graph rewriter 310 rewrites the graph into a form compatible with CUTLASS and cuBLAS to optimize the computational environment.

The graph rewriter 310 may generate an ONNX graph that defines input data as variables and weights and bias data as constants. Also, the graph rewriter 310 adjusts the graph by converting constant data nodes into variable data nodes to ensure compatibility with the cuBLAS library. For example, converting weight data defined as constants into variables in the fully connected layers of GPT or BERT models may improve computational efficiency.

The graph rewriter 310 may analyze operation node patterns based on the CUTLASS and cuBLAS pattern tables to generate optimized General Matrix Multiplication (GEMM) operation nodes. For example, when the GEMM operation is followed by the Add operation, the graph rewriter 310 may merge the two operations into a single GEMM-Add kernel to reduce unnecessary computation steps.

The graph rewriter 310 splits the input ONNX graph into a CUTLASS-friendly graph and a cuBLAS-friendly graph based on the identified operation pattern and ultimately generates a TVM graph IR. During this process, the graph rewriter 310 rewrites the graph according to each pattern to enable subsequent optimization tasks.

The runtime engine unit 320 provides a function of receiving the TVM graph IR converted by the graph rewriter 310; performing a tiling search, module generation, and performance comparison to generate optimized executable binaries; and performing LLM inference.

The runtime engine unit 320 may search for tiling parameters for each operation node through the tiling execution member and apply the optimal tiling configuration. The tiling configuration process involves setting the optimal tile size by considering the memory bandwidth and characteristics of the compute core of the hardware.

For example, the runtime engine unit 320 may analyze the TVM graph of the GPT model and set the optimal tile size (e.g., 64×64) for each operation node. The runtime engine unit 320 may dynamically adjust the tile size through a brute-force search or apply node-specific optimal tiling parameters to maximize computational performance.

The runtime engine unit 320 may generate both CUTLASS and cuBLAS modules based on the searched tiling configuration. The generated two modules are used to perform comparison of execution performances using the same input data.

The runtime engine unit 320 may evaluate criteria such as execution time, memory usage, and power consumption to select the optimal module. For example, in an environment with limited GPU memory bandwidth, the CUTLASS module may provide better performance by maximizing memory utilization. On the other hand, in a case requiring high computational loads and large-scale matrix operations, the cuBLAS module may achieve higher computational efficiency.

The runtime engine unit 320 may compare the performances of the CUTLASS module and the cuBLAS module through the execution performance comparison member and generate an executable binary based on the most efficient module. For instance, if the CUTLASS module exhibits better performance, a CUTLASS-based binary may be generated, whereas, if the cuBLAS module proves to be more efficient, a cuBLAS-based executable file may be built.

The runtime engine unit 320 may generate both modules based on the same input data and evaluate the execution environment in real-time to automatically select an appropriate binary. Also, the runtime engine unit 320 may compare execution performances across various acceleration devices, such as GPUs and TPUs, and configure the optimal execution path.

The binary execution member may execute the generated executable binary in a GPU environment and perform LLM inference tasks. For example, the runtime engine unit 320 may run the binary optimized for an NVIDIA A100 GPU to process input data for the GPT model and perform an inference task predicting the next word.

Also, the runtime engine unit 320 may be configured to execute binaries on hardware acceleration devices such as FPGAs, in addition to GPUs. In a cloud environment, multiple GPUs may be utilized in parallel to perform large-scale inference tasks.

Finally, the LLM execution engine apparatus 130 may provide a function of analyzing and converting the Open Neural Network Exchange (ONNX) graph of an input LLM model, generating an optimized runtime binary, and performing LLM inference.

The graph rewriter 310 may transform the input ONNX graph into a Tensor Virtual Machine (TVM) graph, optimize a computational pattern, and rewrite the graph to be compatible with hardware acceleration devices; subsequently, the runtime engine unit 320 may perform a tiling search, module generation, and performance comparison to generate the optimal execution binary.

The generated executable binary may be run on various hardware environments including GPUs, CPUs, and FPGAs, through which the execution performance of an LLM model may be maximized, and an efficient and reliable inference result may be provided.

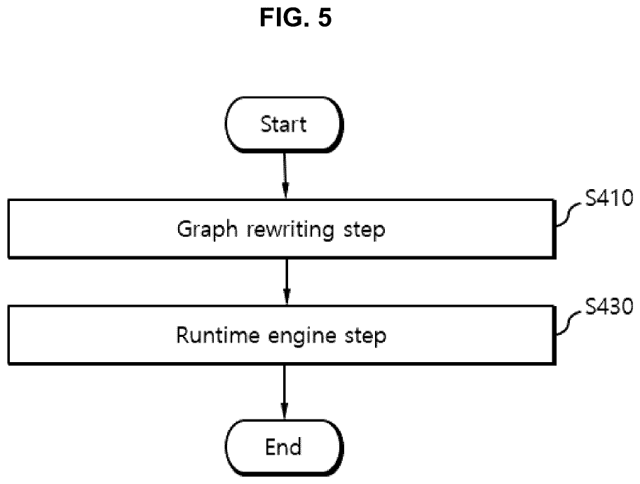

FIG. 5 is a flow diagram illustrating the LLM execution engine procedure performed in the LLM execution engine apparatus of FIG. 1.

FIG. 5 comprises a graph rewriting step S410 and a runtime engine step S430.

In the graph rewriting step S410, the input LLM model may be analyzed through the graph rewriter 310 to generate an ONNX graph. The generated ONNX graph may be searched for computational patterns, transformed into an optimized form, and rewritten into a Tensor Virtual Machine (TVM) graph. In the graph rewriting step S410, constant data nodes may be converted into variable data nodes, and the graph structure may be optimized to be compatible with CUTLASS and cuBLAS libraries.

In the runtime engine step S430, the runtime engine unit 320 may receive the TVM graph generated in the graph rewriting step as input to generate an optimized executable binary. In the runtime engine step S430, the runtime engine unit 320 may search for tiling parameters and apply the optimal tiling configuration. Subsequently, CUTLASS and cuBLAS modules may be generated, and their execution performances may be compared to select the optimal module. Finally, the runtime engine unit 320 may generate an executable binary based on the selected module and perform LLM inference in a hardware-accelerated environment (e.g., a GPU, CPU, or FPGA).

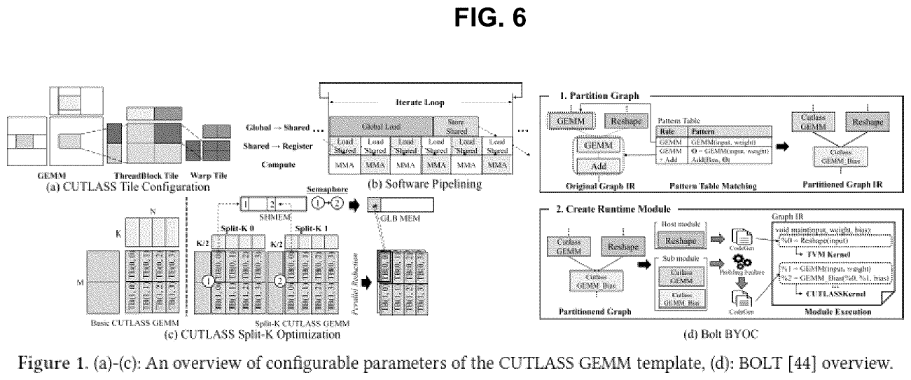

FIG. 6 illustrates graph optimization and execution process based on the conventional methods, CUTLASS and TVM BYOC.

Referring to FIG. 6, conventional techniques introduce methods for improving computational performance through processes such as tiling configuration, software pipelining, Split-K optimization, and integration with external libraries.

In FIG. 6(a), the conventional CUTLASS library divides the entire computational output into Threadblock Tiles and Warp Tiles to optimize General Matrix Multiplication (GEMM) operations. The Threadblock Tile is a unit block that processes the GEMM output, and each Threadblock Tile is further partitioned into Warp Tiles. Such tiling configurations are designed with a three-dimensional structure to maximize GPU resource utilization, and adjusting the size and shape of the tiles may significantly impact the GPU performance.

In FIG. 6(b), the CUTLASS library utilizes a software pipelining technique to hide the computation latency of GPU. Software pipelining is structured to execute three streams (memory transfer and computation) in parallel. The first stream transfers data from global memory to shared memory, the second stream moves data from shared memory to register files, and the final stream performs computations. This pipelining enables efficient use of GPU memory bandwidth and computational resources. Specifically, when combined with tile configurations (as shown in FIG. 6(a)), the latency of each stream may be minimized.

In FIG. 6(c), Split-K optimization is a technique that splits the K-dimension of GEMM operations to perform parallel computations. The K-dimension is split into multiple Threadblock Tiles, and operations are performed independently on each tile, followed by parallel reduction to obtain the final result. Also, CUTLASS applies semaphore-based memory access control to prevent race conditions. For example, when a specific Threadblock Tile accesses global memory, CUTLASS controls access by other Threadblock Tiles to ensure data integrity.

In FIG. 6(d), the Bring Your Own Code (BYOC) framework of TVM converts the input TVM Graph IR into optimized execution kernels based on user-defined patterns and external libraries (e.g., CUTLASS and cuBLAS). FIG. 6(d) illustrates the process of replacing nodes of the input Graph IR with CUTLASS GEMM and cuBLAS kernels through TVM BYOC and adjusting compile options like tile configurations to optimize execution performance. TVM BYOC may provide an optimal execution environment by utilizing external libraries according to user-defined pattern tables.

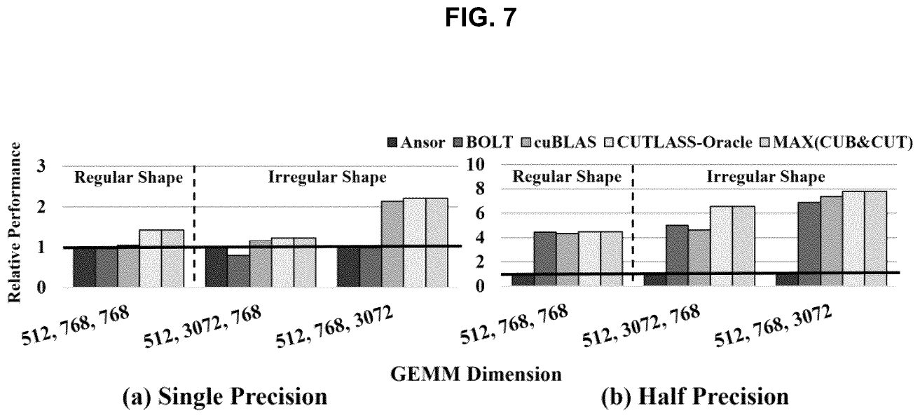

FIG. 7 shows comparison of General Matrix Multiplication (GEMM) operation performances according to conventional methods.

FIG. 7 illustrates relative performances measured according to various operation dimensions and shapes (regular shape and irregular shape) in the single-precision and half-precision computational environments.

FIG. 7(a) illustrates the GEMM operation performance in the single-precision environment. The X-axis represents the dimensions of the GEMM operation, identified as three cases: (512, 768, 768), (512, 3072, 768), and (512, 768, 3072). These computational dimensions are divided into Regular Shape and Irregular Shape categories, and the Y-axis represents relative performance, comparing the performance improvements over existing methods. For Regular Shape category, BOLT and CUTLASS-Oracle outperform existing methods like Ansor and cuBLAS, and for Irregular Shape category, CUTLASS-Oracle and MAX (CUB&CUT) exhibit relatively superior performance.

FIG. 7(b) illustrates the GEMM operation performance in the half-precision environment. In the same way as the single-precision case, the X-axis includes GEMM dimensions of (512, 768, 768), (512, 3072, 768), and (512, 768, 3072), divided into Regular Shape and Irregular Shape categories. The Y-axis represents relative performance, and, in the Regular Shape category, BOLT and CUTLASS-Oracle consistently outperform existing methods. On the other hand, in the Irregular Shape category, CUTLASS-Oracle and MAX (CUB&CUT) achieve relatively higher performance, demonstrating significant improvement even for irregular dimensions.

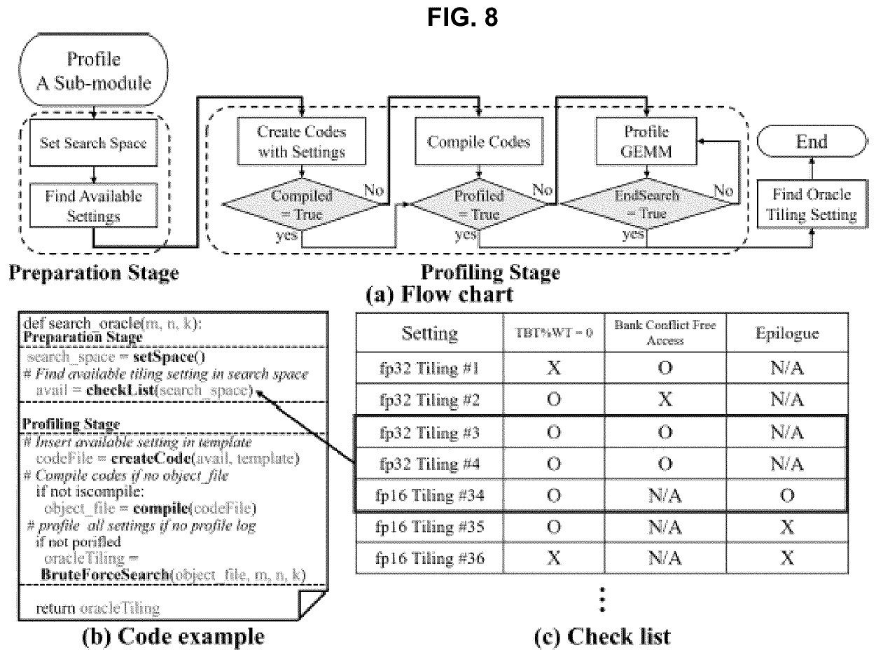

FIG. 8 illustrates the step-by-step search process for optimizing the tiling configuration of CUTLASS according to conventional methods.

FIG. 8 comprises a preparation stage and a profiling stage and systematically illustrates the process of tiling configuration search and optimization.

In the preparation stage, the search space for tiling configurations is defined, and a filtering process is conducted to identify valid configurations. First, the search space for tiling configurations is established, and unnecessary configurations are removed based on a checklist. The checklist is used to validate a configuration according to conditions such that Threadblock Tile size is set as a multiple of 32, the number of Warps per Threadblock is limited to values between 1 and 8, alignment is set to 1 for single-precision computations, and alignment is applied in multiples of a value between 2 and 8 for half-precision computations. Also, Split-K parameters are set to a value between 1 and 8, and Threadblock Swizzling is defined as a multiple of 2. The preparation stage verifies whether the ratio between Threadblock Tile and Warp Tile satisfies a divisibility condition and configures the use of CUDA cores or Tensor cores based on data precision. The preparation stage also reviews padding sizes for Warp Tiles to avoid bank conflict during shared memory access and eliminates configurations that do not support epilogue operations. Through the preparation stage, only valid tiling configurations are finally forwarded to the profiling stage.

In the profiling stage, the optimal tiling configuration is searched among the valid configurations identified in the preparation stage. The profiling stage begins by inserting the valid tiling configuration as input parameters into the CUTLASS GEMM kernel to generate execution code. Afterward, the profiling stage checks whether the generated code is successfully compiled; if compilation fails, the search process is continued by applying an alternative configuration. A successfully compiled configuration is used for performance profiling to evaluate execution time and memory access efficiency. To minimize unnecessary compilation overhead, previously compiled GEMM binaries are reused, and GEMM nodes of non-connected version are utilized.

The checklist provides criteria for determining the validity of tiling configurations and is used to examine the ratio between Threadblock Tile and Warp Tile, check whether conflicts are avoided during shared memory access, and verify whether epilogue operations are supported.

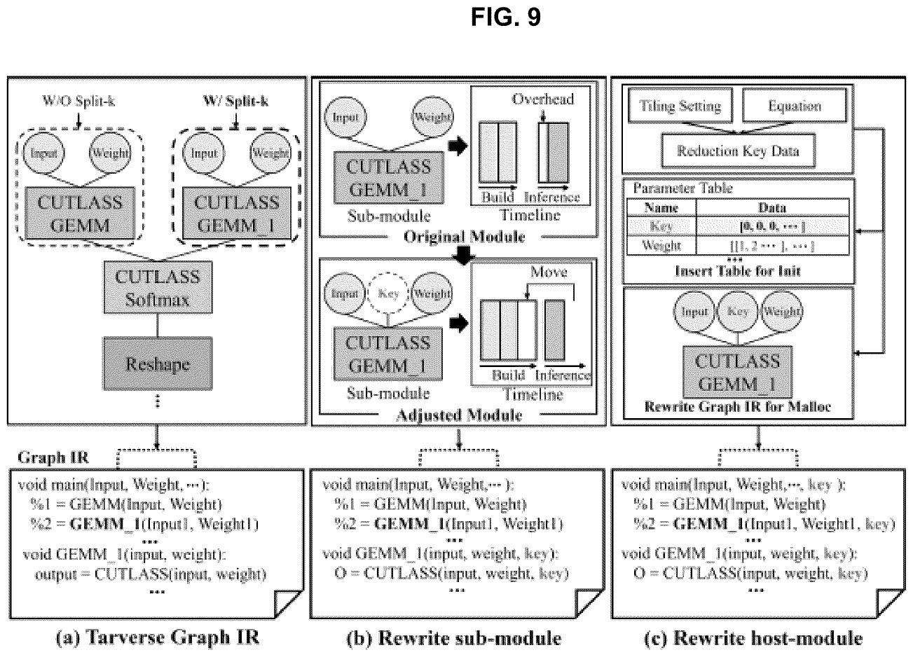

FIG. 9 illustrates CUTLASS-friendly graph intermediate representation (IR) transformation according to conventional methods.

FIG. 9 illustrates a step-by-step process of optimizing the original structure of the Graph IR to reduce the overhead of the Split-K algorithm and improving memory allocation and initialization performance. FIG. 9 illustrates a step-by-step process of optimizing the original structure of the Graph IR to reduce the overhead of the Split-K algorithm and improving memory allocation and initialization performance.

FIG. 9(a) describes the search process of the Graph IR. In the original Graph IR, since the allocation time of reduction keys required for the Split-K algorithm is not properly considered, unnecessary memory allocation may occur during the inference stage. In particular, since multiple reduction keys need to be allocated for LLMs with a large K dimension, efficient utilization of Stream Multiprocessor (SM) resources is important. During the search process of the graph IR, the original graph IR is traversed to identify submodules that utilize CUTLASS GEMM.

FIG. 9(b) illustrates the rewriting process for submodules. When an optimal tiling configuration for applying the Split-K algorithm is identified, the Graph IR is modified to include a reduction key as an input parameter. The reduction key is modified to be allocated and initialized during the build stage, through which unnecessary memory allocation and an initialization delay may be eliminated from the inference stage. The submodule rewriting process shifts allocation of the reduction key to the build stage to improve the execution performance of the graph IR and enhance the inference performance of the overall system.

FIG. 9(c) describes the rewriting process for a host module. The host module registers the reduction key added by the submodule into the input table, and the Graph IR is modified to reflect the corresponding key. Since the reduction key is pre-allocated and initialized during the build stage, the key value may be used directly during the inference stage without additional initialization. The rewriting process of the host module eliminates runtime overhead related to the allocation of the reduction key and supports the Split-K algorithm to operate efficiently.

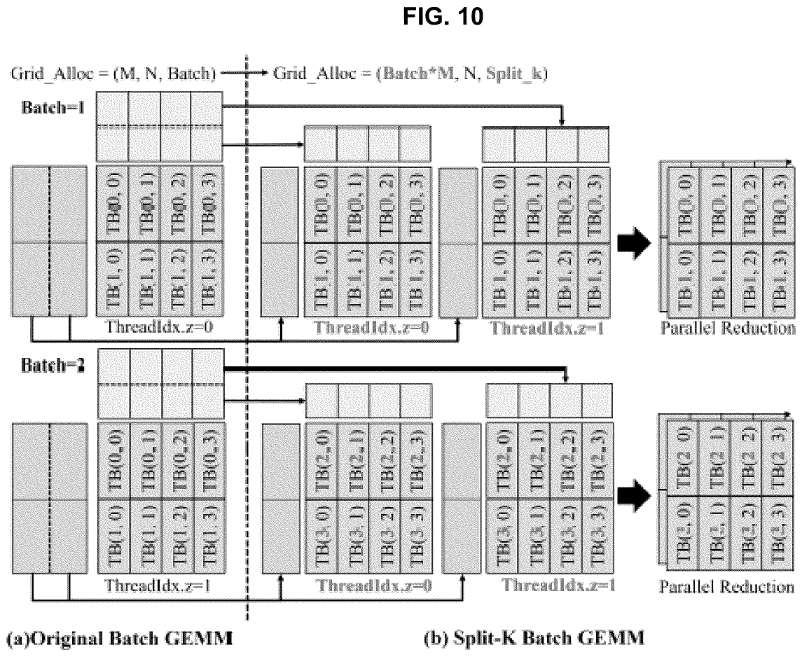

FIG. 10 illustrates a process of maximizing utilization of computational resources of GPUT by applying the Split-K algorithm to the Batch GEMM operation.

FIG. 10(a) shows the structure of the conventional Batch GE3MM, while FIG. 10(b) shows the structure of modified Batch GEMM with the Split-K algorithm applied.

The modified Batch GEMM described in FIG. 10 maximizes CPU core utilization, addresses the low efficiency present in the conventional Batch GEMM, and enhances the LLM computation performance through the application of the Split-K algorithm.

FIG. 10 describes the process of applying the Split-K algorithm to Batch GEMM operations to maximize the utilization of GPU computational resources. FIG. 10(a) illustrates the structure of the conventional Batch GEMM. The conventional Batch GEMM structure uses the block index (blockldx.z) as a batch index and processes the output matrix through a 3D thread block structure. In the conventional structure, multiple thread blocks are required to process the same output matrix tile; however, since the block index (blockldx.z) serves as the batch index, the block index may not be used as a semaphore key. This limitation hinders the application of semaphore algorithms, which prevents optimal utilization of GPU computational resources in the conventional Batch GEMIM.

FIG. 10(b) illustrates the modified Batch GEMM structure with the Split-K algorithm applied. In the modified Batch GEMM structure, the block index (blockIdx.x) is redefined as the batch index, and the 3D thread block structure is transformed into a 2D structure. During this step, the block index (blockldx.z) is made available as the semaphore key index, allowing the semaphore algorithm employed in the existing CUTLASS GEMM to be applied to the Batch GEMM.

The modified Batch GEMM allocates multiple thread blocks to the same output matrix tile and performs Matrix Multiply-Accumulate (MMA) operations in parallel.

Subsequently, the semaphore algorithm controls the sequential accumulation of results stored in global memory. Through this process, the Batch GEMM with the Split-K algorithm fully utilizes the stream multiprocessors (SMs) of GPU.

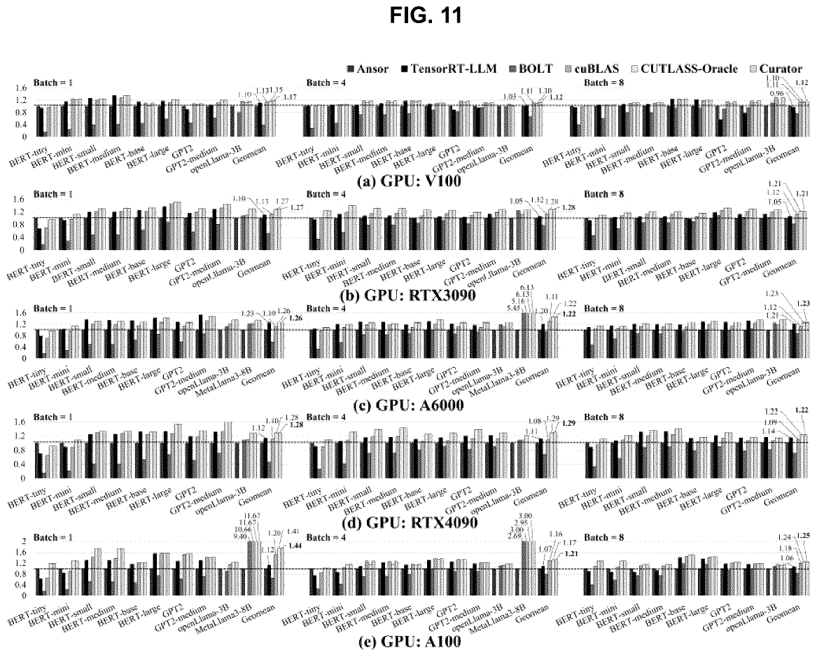

FIG. 11 is a diagram of comparing LLM single-precision inference performances of CUrator and other frameworks in diverse GPU environments.

FIG. 11 quantitatively evaluates the relative performance due to various batch sizes for five GPIUs, including V100, RTX 3090, A6000, RTX 4090, and A100. Referring to FIG. 11, CUrator demonstrates superior performance compared to other frameworks in all GPU environments and batch sizes for single-precision LLM inference tasks.

FIG. 11(a) illustrates the single-precision inference performance on the V100 GPU. On average, CUrator achieves higher performance than other frameworks on the V100 GPU; however, in some cases with batch sizes of 4 and 8, cuBLAS outperforms. This result occurs from specific algorithmic differences; in this case, CUrator optimizes performance by selecting the faster module between CUTLASS and cuBLAS modules.

FIG. 11(b) shows the performance comparison results on the RTX 3090 GPU. In most cases, regardless of batch size, CUTLASS-Oracle achieved the highest performance, with CUrator outperforming other frameworks. Notably, as the batch size increases, CUrator achieves even greater performance improvement. It is so because the optimized tiling configuration of CUTLASS GEMM effectively utilizes GPU resources.

FIG. 11(c) illustrates the inference performance on the A6000 GPU. On the A6000, too, CUrator demonstrates superior performance compared to other frameworks on average and achieves relatively large performance improvement even for batch sizes of 4 and 8. Based on the tiling configuration of CUTLASS-Oracle, CUrator optimizes the compute cores of CPU and memory bandwidth to maximize performance.

FIG. 11(d) illustrates the performance comparison on the RTX 4090 CPU. On the RTX 4090, CUrator on average outperforms other frameworks, with the most significant performance improvement observed at a batch size of 4. It is so because the Split-K algorithm and tiling optimization, which maximizes the computational capabilities of GPU, play a critical role.

FIG. 11(e) illustrates the inference performance on the A100 GPU. On the A100, too, CUrator achieves the highest performance, with up to 1.44 times performance improvement over existing frameworks for batch sizes of 4 and 8. This result is obtained since optimized GEMM operations based on the CUTLASS-Oracle efficiently utilizes high-performance compute cores of A 100 GPU.

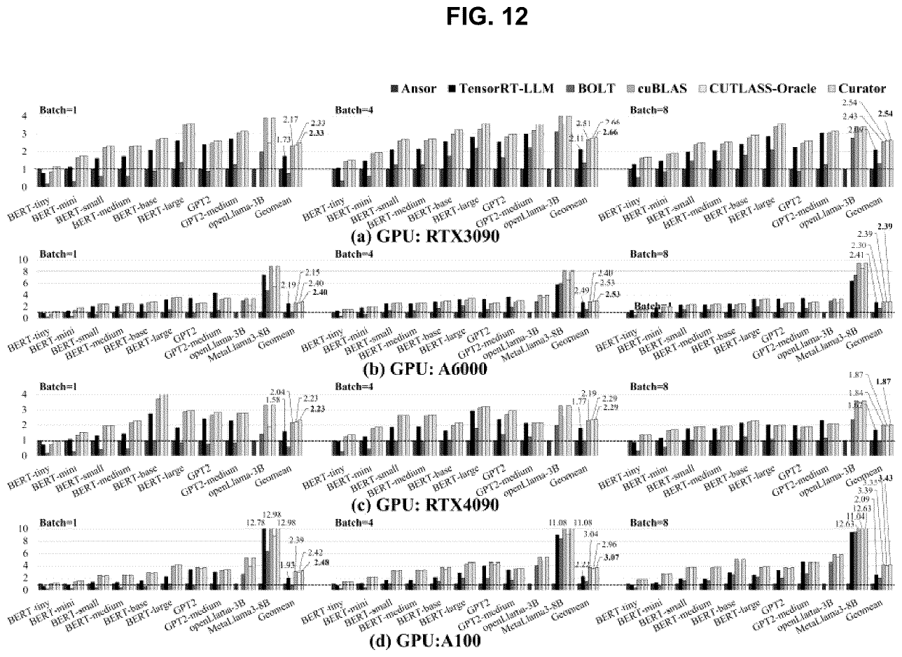

FIG. 12 is a diagram comparing half-precision LLM inference performances measured on RTX3090, A6000, RTX4090, and A100 GPUs.

According to FIG. 12, the performance comparison results show that CUrator maximizes the performance of the CUTLASS GEMM kernel through optimal tiling configuration or optimizes inference performance by selecting the cuBLAS kernel in specific cases.

FIG. 12(a) shows the performance evaluation result on the RTX 3090 GPU. CUrator demonstrates 1.03 times improvement in terms of average performance based on the CUTLASS-Oracle and cuBLAS. Notably, CUrator efficiently utilizes GPU resources as the batch size increases, achieving high inference performance.

FIG. 12(b) shows the performance evaluation on the A6000 GPU. CUrator exhibits 1.02 times performance improvement in terms of average performance and consistently outperforms in both BERT and GPT models. On the other hand, Ansor shows relatively low performance due to its inability to finely optimize specific GPU resources.

FIG. 12(c) shows the performance evaluation result on the RTX 4090 CPU. CUrator achieves 1.02 times performance improvement by integrating CUTLASS-Oracle and cuBLAS, demonstrating superior results for most models and batch sizes. However, for some large-scale models, performance degradation is observed due to inefficiencies in the TVM interface.

FIG. 12(d) shows the performance evaluation result on the A100 GPU, CUrator achieves 0.95 times performance improvement in terms of average performance; however, for large-scale models such as the MetaLlama3-8B, TensorRT-LLM exhibits superior performance through LLM-specific optimization, including operation fusion and graph optimization.

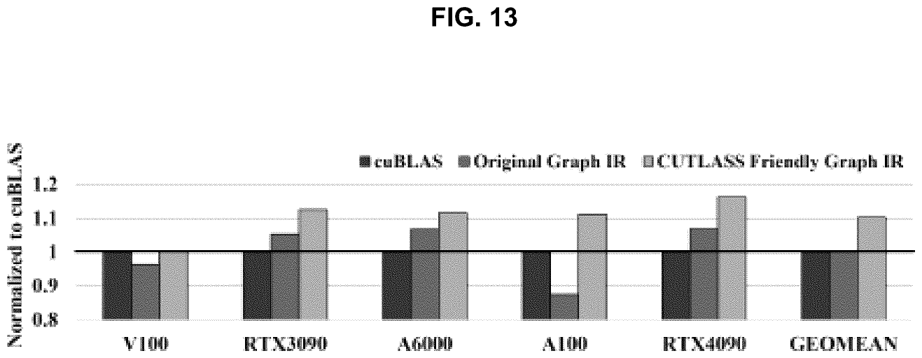

FIG. 13 is a diagram evaluating single-precision inference performance of the BERT model by comparing the CUTLASS-friendly graph IR and the conventional graph IR.

Referring to FIG. 13, the CUTLASS-friendly graph IR consistently achieves superior performance compared to the conventional graph IR across various CPU environments.

On the V100 GPU, the CUTLASS-friendly graph IR demonstrates 1.04 times performance improvement on average compared to the conventional graph IR. On the RTX 3090 GPU, 106 times performance improvement on average is observed, attributed to the optimization of compute cores and resources of GPU. On the A6000 GPU, 1.04 times performance improvement on average is obtained; on the A100 GPU, the performance is maximized up to 1.26 times on average by applying the Split-K algorithm based on a plurality of Stream Multiprocessor (SM) structure. The RTX 4090 GPU achieves average performance improvement of 1.08 times by effectively utilizing GPU cores.

The GEOMEAN value indicates that the CUTLASS-friendly graph IR provides an average performance improvement of 1.08 times over the conventional graph IR for all GPU environments. As the number of compute cores in modern GPUs increases, applying the Split-K algorithm anew or adjusting existing configuration parameters may contribute to performance optimization. Also, pre-processing overheads such as reduction key memory allocation in the build time rather than in the runtime allows for more efficient utilization of GPU resources, thereby maximizing the performance enhancement effect,

In conclusion, the CUTLASS-friendly graph IR consistently provides superior performance compared to the conventional graph IR in various GPU environments. Efficient utilization of GPI resources and optimization of the Split-K algorithm play a critical role in improving inference performance.

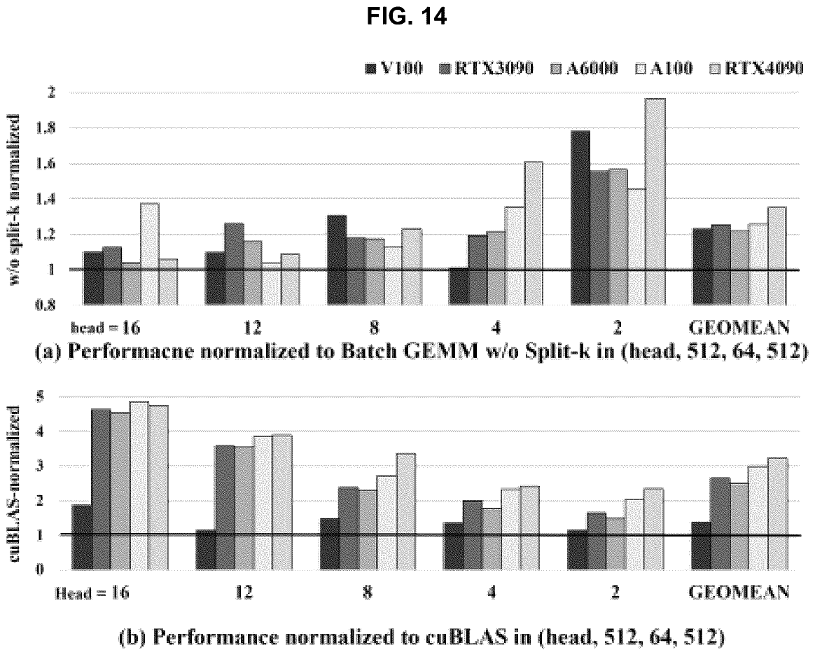

FIG. 14 is a diagram comparing the performance obtained by applying the Split-K option to Batch GEMM in the BERT model and the performance obtained when the Split-K option is not applied.

FIG. 14(a) shows a graph normalizing the performance of Batch GEMM with the Split-K option against the performance of Batch GEMM without the Split-K option.

Referring to FIG. 14(a), it is observed that as the number of GPU cores increases, Batch GEMM with the Split-K option applied demonstrates relatively higher performance. Particularly, as the number of heads decreases, i.e., as the size of computation becomes small, the performance improvement from application of the Split-K option becomes more pronounced. For example, when the number of heads is 2 on the A100 and RTX 4000 GPUs, the performance improves by approximately 1.6 times and 1.8 times, respectively. This result is obtained because the Split-K algorithm performs computations by utilizing multiple thread blocks simultaneously, which leads to more efficient utilization of compute cores of a GPU.

FIG. 14(b) shows a graph normalizing the performance of Batch GEMM with the Split-K option against the performance of cuBLAS Batch GEMM. Referring to FIG. 14(b), it is observed that when the number of heads is small, the performance of Batch GEMM with the Split-K option applied significantly surpasses that of cuBLAS. Notably, on RTX 4090 and A100 CPUs, the performance improvement is substantial, achieving a performance improvement up to 4 times or more compared to that of cuBLAS even when the number of heads is 16. This result is obtained since the Split-K algorithm effectively partitions the core resources of a GPU, and the parallel operation approach is more efficient that the single operation approach employed in the cuBLAS.

In conclusion, the Batch GEMM4 with the Split-K option applied optimizes the use of compute cores of a GPU, maximizing performance. The performance enhancement from the application of the Split-K algorithm is particularly notable for smaller computation sizes, and the performance enhancement is significant as the number of compute cores in modern GPUs grows.

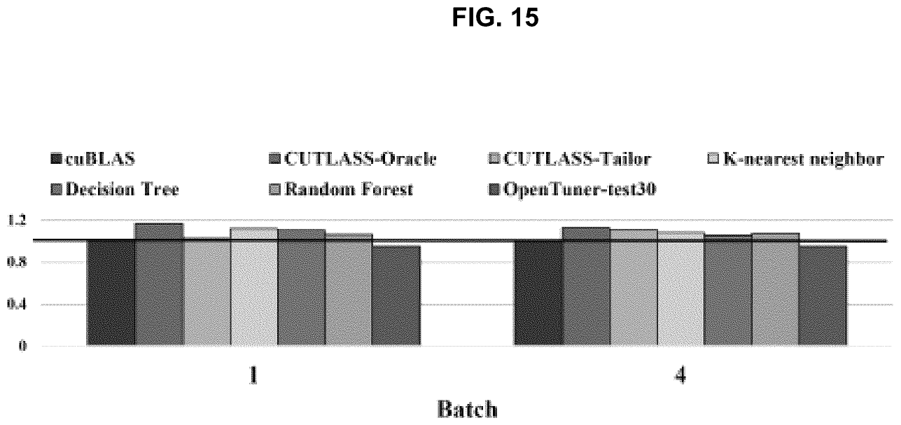

FIG. 15 illustrates an evaluation result when an auto-tuner is introduced to the CUTLASS backend for the OpenLlama-3B model.

Referring to FIG. 15, six types of auto-tuners are used for evaluation, including OpenTuner and machine learning (TL)-based tuners; these tuners are analyzed to evaluate their performance using CUTLASS Oracle and cuBLAS as comparison criteria.

According to the graph results, the ML-based tuner learns GEMM profiling information in the BERT and GPT2 models and predicts the optimal tiling configuration for target GEMM operations in the OpenLlama-3B model. The graph shows that although the ML-based tuner does not achieve the performance level of the CUTLASS Oracle, it outperforms cuBLAS. This observation indicates that although ML-based prediction partially utilizes the capabilities of a GPU, full optimization is still unattainable.

On the other hand, OpenTuner fails to find appropriate tiling configurations compared to the ML-based tuner or CUTTLASS Oracle even though OpenTuner is tested 30 times more against the GEMM operation. These results suggest that OpenTuner exhibits limited performance in searching for tiling configurations, failing to fully utilize the performance provided by a GPU.

Overall, the experimental results indicate that while CUTLASS Oracle still demonstrates the highest performance, the ML-based auto-tuner also achieves a particular level of performance improvement.

Although the present disclosure has been described with reference to preferred embodiments given above, it should be understood by those skilled in the art that various modifications and variations of the present disclosure may be made without departing from the technical principles and scope specified by the appended claims below.

### DETAILED DESCRIPTION OF MAIN ELEMENTS

100: LLM execution engine system
110: User terminal
130: LLM execution engine apparatus
150: Database
210: Processor 230: Memory
250: User input/output unit 270: Network input/output unit
290: Communication port unit
310: Graph rewriter
320: Runtime engine unit
330: Controller

### National Research and Development Project Supporting The Present Invention

[Project Serial No]2710006677
[Task Project No] RS-2020-II201361
[Name of department] Ministry of Science and CI
[Task management (professional) institution name] Information and Communication Planning and Evaluation institute
[Research Project name] Information and Communication Broadcasting innovation Talent Training (R&D)
[Research Task Name] Artificial Intelligence Graduate School Support (Yonsei University)
[Name of task performing organization] University Industry Foundation, Yonsei University
[Research Period]2024.01.01˜2024.12.31
[National Research and Development Project Supporting The Present Invention]
[Project Serial No]2710008644
[Task Project No] II210310
[Name of department] Ministry of Science and ICT
[Task management (professional) institution name] Information and Communication Planning and Evaluation Institute
[Research Project name] Fundamental Technology Development for Software Computing Industry
[Research Task Name] Development of Core Technologies for On-Device Robot Intelligence Support Software Platform
[Name of task performing organization] Hanyang University
[Research Period]2024.01.01˜2024,12.31
[National Research and Development Project Supporting The Present Invention]
[Project Serial No]2710008233
[Task Project No]00339187
[Name of department] Ministry of Science and ICT
[Task management (professional) institution name] Information and Communication Planning and Evaluation Institute
[Research Project name] Fundamental Technology Development for Software Computing Industry
[Research Task Name] Development of Core Technologies for On-Device Robot Intelligence Support Software Platform
[Name of task performing organization] Electronics and Telecommunications Research Institute
[Research Period]2024.04.01˜2024.12.31

What is claimed is:

1. A Large Language Model (LLM) execution engine apparatus comprising:
a graph rewriter that analyzes an Open Neural Network Exchange (ONNX) graph and converts the graph into a Tensor Virtual Machine (TVM) graph; and
a runtime engine unit that compiles the TVM graph into an executable binary.

2. The apparatus of claim 1, wherein the graph rewriter converts an LLM model into the ONNX graph, and the ONNX graph includes an ONNX graph generation member that defines input data as variables and weights as constants.

3. The apparatus of claim 2, wherein the graph rewriter further includes an ONNX graph processing member that transforms the constants in the ONNX graph into the variables, modifies the ONNX graph into a form compatible with CUDA Templates for Linear Algebra Subroutines (CUTLASS) and CUDA Basic Linear Algebra Subroutines (cuBLAS), and identifies a computational pattern.

4. The apparatus of claim 3, wherein the graph rewriter further includes a TVM graph generation member that splits the modified ONNX graph based on the computational pattern to generate the TVM graph.

5. The apparatus of claim 4, wherein the graph rewriter determines the computational pattern mainly from General Matrix Multiplication (GEMM) operations.

6. The apparatus of claim 1, wherein the runtime engine unit includes a tiling execution member that receives the TVM graph as input, searches tiling parameters of the TVM graph, and performs tiling configuration.

7. The apparatus of claim 6, wherein the runtime engine unit further includes an execution performance comparison member that generates CUTLASS and cuBLAS modules based on the tiling configuration and compares their execution performances.

8. The apparatus of claim 7, wherein the runtime engine unit further includes a binary generation member that selects one of the CUTLASS and cuBLAS modules to generate the binary.

9. The apparatus of claim 8, wherein the runtime engine unit further includes a binary execution member that performs LLM inference using the binary in a GPU environment.

10. An LLM execution engine apparatus comprising:
a graph rewriter that analyzes an ONNX graph and converts the graph into a TVM graph; and
a runtime engine unit that compiles the TVM graph into a binary,
wherein the graph rewriter converts an LLM model into the ONNX graph that defines input data as variables and weights as constants, transforms the constants in the ONNX graph into the variables, modifies the ONNX graph into a form compatible with CUTLASS and cuBLAS, identifies a computational pattern, and splits the modified ONNX graph based on the computational pattern to generate the TVM graph; and
the runtime engine unit receives the TVM graph and performs tiling configuration by searching for tiling parameters of the TVM graph, generates CUTLASS and cuBLAS modules based on the tiling configuration and compares their execution performances, selects one of the CUTLASS and cuBLAS modules to generate the binary, and performs LLM inference using the binary in a GPU environment.

11. A Large Language Model (LLM) execution engine method performed by an LLM execution engine apparatus, the method comprising:
a graph rewriting step that analyzes an Open Neural Network Exchange (ONNX) graph and converts the graph into a Tensor Virtual Machine (TVM) graph; and
a runtime engine step that compiles the TVM graph into an executable binary.
